(19) United States
(12) Patent Application Publication
(10) Pub. No.: US 2025/0088139 A1
(43) Pub. Date: Mar. 13, 2025

(54) CLAMPING ASSEMBLY FOR MOUNTING SOLAR PANEL MODULES

(71) Applicant: Unirac, Inc., Albuquerque, NM (US)

(72) Inventors: Tarun Kumar Polanky, Hyderabad Telangana (IN); Nikhil Babu, Hyderabad Telangana (IN); Sindhu Madhavi Gopalam, Hyderabad Telangana (IN); Ronald Gary Norman, Louisville, CO (US); Jeffrey Ballard, Albuquerque, NM (US)

(21) Appl. No.: 18/826,806

(22) Filed: Sep. 6, 2024

Related U.S. Application Data
(60) Provisional application No. 63/537,321, filed on Sep. 8, 2023.

(51) Int. Cl. H02S 20/30

(52) U.S. Cl. CPC H02S 20/30

(57) ABSTRACT

A clamp assembly for securing a solar panel module includes a clamp base, a clip movably connected to the clamp base, and a biasing fastener extending through the clamp base and the clip. The biasing fastener is configured to bias the clip from the clamp base.

### RELATED PATENT APPLICATION

This application claims priority to and the benefit of U.S. Provisional Patent Application No. 63/537,321, filed on Sep. 8, 2023, entitled “Clamp for mounting solar panel modules,” and incorporates the content thereof in its entirety by reference.

### BACKGROUND

The solar industry is experiencing rapid growth on a global scale, driving an increasing demand for effective and reliable mounting systems to secure solar panel modules (also referred to as PVs, photovoltaic modules, etc.) to various structures, such as roofs or other surfaces. Although there is a wide range of existing mounting solutions, there remains a strong desire to simplify the complexity and improve the efficiency of these systems while ensuring they maintain their essential anchoring integrity. With solar energy playing a crucial role in the shift toward sustainable energy, the development of more advanced, user-friendly, and robust mounting equipment is needed.

A significant number of solar panel modules are installed on rooftops, which presents unique challenges and risks. The elevated location increases the danger of falls and potential injury to the individuals tasked with installing the mounting equipment. Moreover, the complexity and variety of existing mounting systems often require installers to carry multiple tools up and down ladders and across rooftops, complicating the installation process and increasing the risk of accidents. Given these challenges, there is a pressing need for an improved mounting system.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical components or features. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1 illustrates an isometric view of a clamp assembly connected to a rail R, according to an embodiment of this disclosure.

FIG. 2A illustrates an isometric view of the clamp base as depicted in FIG. 1, according to an embodiment of this disclosure.

FIG. 2B illustrates another isometric view of the clamp base as depicted in FIG. 1, according to an embodiment of this disclosure.

FIG. 2C illustrates yet another isometric view of the clamp base as depicted in FIG. 1, according to an embodiment of this disclosure.

FIG. 3 illustrates a bottom isometric view of the clip depicted in FIG. 1, according to an embodiment of this disclosure.

FIG. 4A illustrates an expanded view of a solar panel module mounting system before installation of a solar panel module, according to an embodiment of this disclosure.

FIG. 4B illustrates a partial view of the solar panel module mounting system depicted in FIG. 4A, showing an intermediate stage of the installation process for the solar panel module 408, according to an embodiment of this disclosure.

FIG. 4C illustrates a partial view of the solar panel module mounting system depicted in FIG. 4A, showing the final stage of the installation process for the solar panel module, according to an embodiment of this disclosure.

FIG. 5A illustrates a side view of the clamp assembly long with a frame of the solar panel module in a first stage of the clamping process, according to an embodiment of this disclosure.

FIG. 5B illustrates a side view of the clamp assembly along with the frame of the solar panel module during a second stage of the clamping process, according to an embodiment of this disclosure.

FIG. 5C illustrates a side view of the clamp assembly along with the frame of the solar panel module during a third stage of the clamping process, according to an embodiment of this disclosure.

FIG. 6 illustrates a cross-sectional view of the clamp base along with the rail R as seen from line A-A′ in FIG. 5A, according to an embodiment of this disclosure.

### DETAILED DESCRIPTION

This application relates to a clamping assembly for mounting solar panel modules to a mounting surface of a platform such as a rooftop.

In an embodiment, a clamp assembly may attach pivotally to a rail of a solar array mounting system to clamp onto a return flange of a frame of a solar panel module. The clamp assembly may include a clamp base and a clip movably connected to the clamp base. The clip may be fastened to the clamp base via a biasing fastener, such that the clip is movable in a first direction away from the clamp base, as well as slidably movable in a second direction that is a longitudinal direction relative to the clamp base.

In an embodiment, a method of using the clamp assembly may include the following operations. Upon placing a solar panel module frame on the clamp base, the clip may be: 1) pulled in the first direction away from the clamp base along the axis of the biasing fastener holding the clip to the clamp base, 2) rotated about the axis of the fastener and/or slid along the clamp base (via the clamp opening such as a slotted aperture therethrough) in the longitudinal direction, and 3) returned toward the clamp base (e.g., via a spring bias and/or threaded means, etc.) to clamp against the inner surface of the return flange of the frame of the solar panel module.

In an embodiment, the clamp base of the clamp assembly may be formed of folded sheet metal, for example. Other suitable materials and means of formation are within the scope of this disclosure, such as a molded plastic or other material, assuming the requisite strength and durability characteristics are met. Nevertheless, in an embodiment, the clamp base may include a panel flange support wall, a first clamp sidewall, and a second clamp sidewall, where the first clamp sidewall and the second clamp sidewall are spaced apart sufficiently to accommodate a rail (e.g., a rail for mounting solar panel array modules) therebetween. The first and the second clamp sidewalls may extend away from and transversely to the panel flange support wall to which the clip is connected. A mounting opening may be formed in the corresponding respective ends of each of the first and second clamp sidewalls such that the mounting openings are coaxial. Further, the first and second clamp sidewalls extend beyond a length of the panel support wall to form a channel therebetween. The channel is sized to accommodate the width of the upper portion of the rail to allow the first and second clamp sidewalls to partially straddle the rail, whereby a pivoting fastener (e.g., a clevis pin) may be inserted through the mounting openings and the rail (forming a pivot joint) to connect the clamp base to the rail. In an embodiment, the mounting openings are aligned laterally to be horizontally positioned when installed on the rail.

The clamp base may further include inwardly-extending, tapered flanges formed, respectively, at a distal edges of the first and second sides, opposite the intersection of the first and second clamp sidewalls with the panel flange support wall. Moreover, the tapered flanges may be disposed on respective ends of the clamp base, opposite the ends in which the mounting openings are located. The tapered flanges may be tapered gradually increasing inwardly to help the clamp assembly engage sidewalls of the rail when mounted on the rail and rotated against the rail. An advantage of the tapered flange may include reducing a tendency for the clamp assembly to wobble on the rail.

In an embodiment, the panel flange support wall of the clamp base may have one or more clamp openings (such as slotted apertures through the thickness direction thereof) such that the biasing fastener (such as a flanged bolt or another like fastener) may be inserted and slidably accommodated therein to connect the clamp base and the clip.

In an embodiment, the clamp base may further include a panel support ledge that extends from and transversely to the panel flange support wall of the clamp base. The panel support ledge is positioned to abut an outside wall of the frame of a solar panel module during installation thereof. As such, the panel support ledge extends away from the panel flange support wall in a direction opposite to the direction of extension of the first and second sidewalls. Additionally, a width direction of the panel support ledge extends in a plane that is orthogonal to respective planes extending through the first and second sidewalls. In an embodiment, the panel support ledge extends at an angle ranging from approximately 25 to 100 degrees, or more, relative to the panel flange support wall of the clamp base, but other angles are also contemplated.

The clamp base may further include a pivot restraining feature formed between the location of the panel support ledge and the location of the mounting openings through the first and second sidewalls. In an embodiment, the pivot restraining feature may include one or more protrusions from one or both of the first and second sidewalls, protruding inward to prevent the clamp base from rotating on the rail beyond a desired stopping point, for example, to prevent a clamped solar panel module from contacting (i.e., forcefully or otherwise) the rail, and/or to limit the amount of rotation of the clamp base and clamped solar panel module to remain in a vertical position. Thus, the stress of the rotational movement of a solar panel module on the rail and mounting structure is minimized.

In an embodiment, the one or more protrusions of the pivot restraining feature may include an inward extending flange bent or otherwise formed with or incorporated into the first and/or second sidewalls. Each of the one or more protrusions may include a vertex point, oriented to interfere with the rotational trajectory of the clamp base about the pivot axis by engagement with an upper wall of the rail. Thus, rotation may be stopped via contact between the horizontal vertex point and the surface of the rail. While the specific shape of the protrusion may vary, in an embodiment as shown, each of the one or more protrusions may be defined as an elongated flange that extends inwardly tapering from one or both ends of the elongation direction thereof, forming a stopping point. In an embodiment, the taper of the elongated flange tapers such that the clamp base would engage a sidewall of the rail in an increasing amount of abutment to slow the engagement and minimize flexion on the pivot joint. In an embodiment, the pivot restraining feature is configured to engage the top surface of the rail when the clamp base is rotated to an upright position that is about 90 degrees (between 80-110) relative to the upper wall of the rail.

As mentioned above, the clip may be formed as an elongated body defined, at least in part by a length dimension, a width dimension, and a thickness dimension. In an embodiment, the clip may further have a clip opening through the thickness dimension thereof. The clip opening may be sized to allow passage of the bolt to connect the clip to the panel support wall of the clamp base. In an embodiment, the clip opening may be threaded. Thus, the biasing fastener such as a bolt may be threaded therethrough such that the clip may function similarly to a “nut” when threaded on the biasing fastener. However, it is conceivable that other connection and tightening means are possible.

Furthermore, in an embodiment, the biasing fastener may have a flanged head and may be positioned such that the flanged head is disposed between the first and second clamp sidewalls of the clamp base, adjacent to the panel support wall of the clamp base. A spring (e.g., a coil spring, a helical spring, a conical spring, etc.) may be disposed between the flanged head of the biasing fastener and an inner-facing surface of the panel support wall of the clamp base. Such an arrangement may bias the clip against the clamp base when the bolt is at least partially threaded into the hole of the clip.

In an embodiment, the clip may further include first and second tabs folded at opposing sides of the clip (in the width dimension, corresponding with the width direction of the clamp base). The folded tabs extend away from the clip and, when connected to the clamp base, the tabs extend over the first and second sidewalls of the clamp base to prevent rotation of the clip. For example, in an embodiment, the tabs may be located at opposite corners at one end of the clip. Further, when clamping, the bolt is tightened and, due to the biased spring, the tabs further facilitate maintaining the clip in place until the tabs are fully engaged against the clamp base. In contrast, when the bolt is loose, the clip may still be rotated when the clip is pulled away from the clamp base.

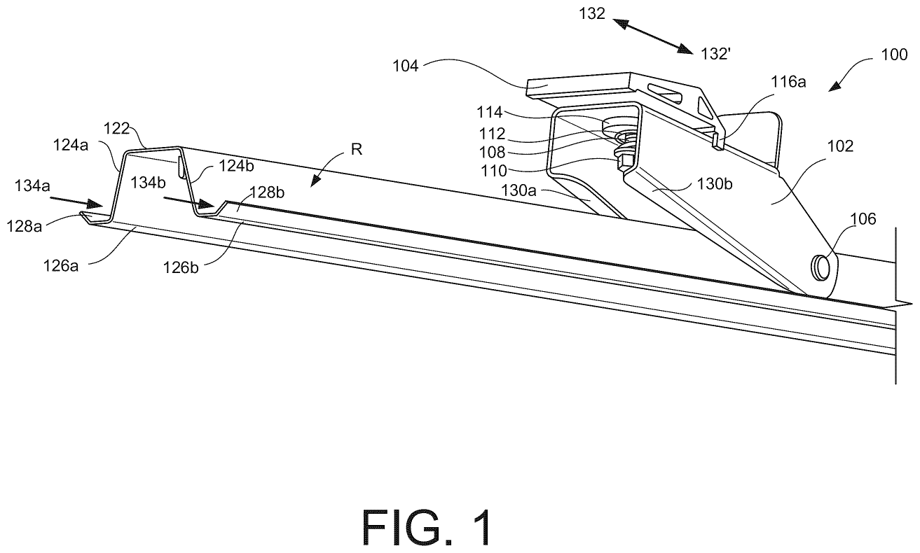

FIG. 1 illustrates an isometric view of a clamp assembly 100 connected to a rail R, according to an embodiment of this disclosure. Referring to FIG. 1, the clamp assembly 100 may include a clamp base 102 and a clip 104. The clamp assembly 100 is configured to be installed on a rail R, which is part of a mounting system for securing solar panel modules or similar equipment. The clamp assembly 100 is configured to be pivotally connected to the rail R, allowing the clamp assembly 100 to rotate or adjust an angle between the clamp assembly 100 and the rail R. Such a pivotal connection is achieved through a pivoting fastener 106, which serves as the axis around which the clamp assembly 100 may rotate relative to the rail R.

The pivoting fastener 106 may be selected from various types of hardware, including, but not limited to, a pin, clevis pin, dowel, rod, bolt, or screw. In the embodiment illustrated in FIG. 1, the pivoting fastener 106 may be a clevis pin. The clevis pin is chosen for its practicality in this context, as the clevis pin simplifies the installation process by allowing easy insertion and removal while providing a reliable and sturdy pivot point.

The clip 104 may be operatively connected to the clamp base 102 in such a way that the clip 104 may slide along the longitudinal direction 132-132′ of the clamp base 102. This sliding mechanism allows for adjustments along the length of the clamp base 102. Additionally, the clip 104 is configured to rotate within a range of at least 0 to 180 degrees relative to the upper surface of the clamp base 102. The rotational capability allows the clip 104 to pivot and align properly with the return flange of a frame of a solar panel module (though not depicted in FIG. 1, details of the return flange of a frame of a solar panel module are described in other parts of this disclosure) during installation. Once the clip 104 is appropriately rotated and slid into a proper position, the clip 104 may be fixed in place by advancing a biasing fastener 108. The biasing fastener 108 may be implemented using various types of mechanical fasteners, including, but not limited to, a pin, clevis pin, dowel, rod, bolt, or screw.

As described herein, the clip 104 may be affixed to the clamp base 102 through the use of the biasing fastener 108. For instance, in an embodiment, the biasing fastener 108 may have a flanged head 110 and may be positioned such that the flanged head 110 is disposed between the first and second clamp sidewalls of the clamp base 102, adjacent to the panel support wall of the clamp base 102.

The clip may include one or more biasing components configured to apply a force to the clip when manually manipulated away from the clamp base. For instance, the biasing components may include a spring 112 and a washer 114 incorporated into the biasing fastener 108. The spring 112 (e.g., a coil spring, a helical spring, a conical spring, etc.) may be disposed between the flanged head of the biasing fastener and an inner-facing surface of the panel support wall of the clamp base 102, to bias the clip 104 against the clamp base 102 when the biasing fastener 108 is at least partially threaded into the clip opening of the clip 104. The inclusion of the spring 112 allows the clip 104 to be biased/rotated with respect to the clamp base 102, applying a constant force that keeps the clip 104 in close proximity to the clamp base 102, and allowing the clip 104 to be manually pulled away when necessary. Once the clip 104 is rotated and positioned properly onto the return flange of the frame of the solar panel module, the spring 112 helps the clip 104 to be drawn back toward the clamp base 102, ready to be fastened into place.

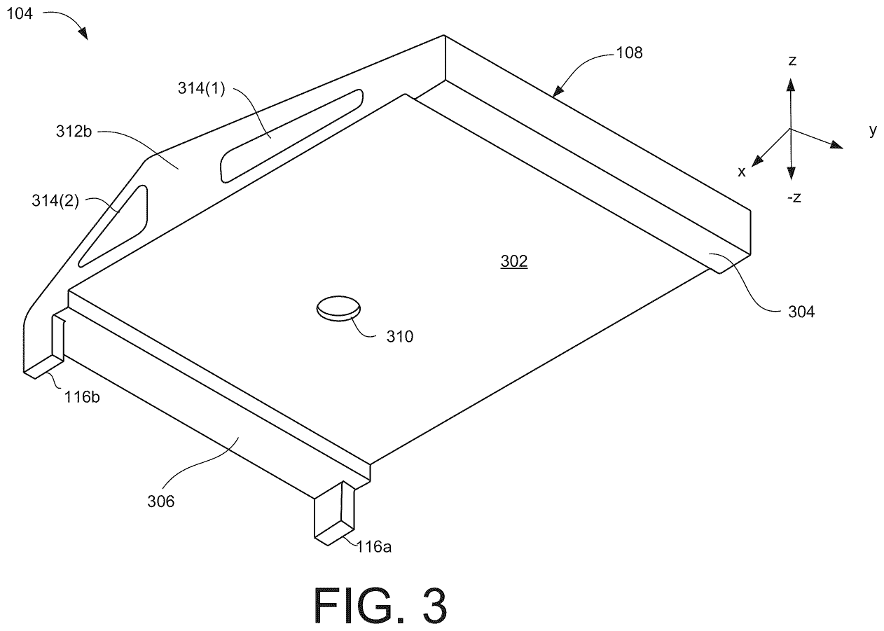

The clip 104 may be configured with one or more tabs on both sides, such as a first tab 116a and a second tab 116b (only the first tab 116a is visible in the view of FIG. 1, while additional details of the second tab 116b are shown in FIG. 3). When the clip 104 is engaged with the clamp base 102, the first tab 116a on one side and the second tab 116b on the opposite side work together to restrict axial rotation of the clip 104 around the axis of the biasing fastener 108. On the other hand, when the clip 104 is pulled upward from the clamp base 102, the clip 104 becomes capable of rotating freely up to 360 or more, depending on the required rotational freedom.

The clamp base 102 may further include a first tapered flange 130a and a second tapered flange 130b. The tapered flanges 130a and 130b are configured to match the configuration (such as the sizes, the shapes, the angles, or the like) of the first and second beveled sidewalls 124a and 124b of the rail R. For example, the taper angles of the first and second tapered flanges 130a and 130b may be configured to correspond with the inclination of the first and second beveled sidewalls 124a and 124b, respectively.

The rail R may be configured to complement and fit features of the clamp assembly 100. For instance, the rail R may include an upper wall 122 flanked by two sidewalls, namely a first beveled sidewall 124a and a second beveled sidewall 124b. The beveled sidewalls 124a and 124b may extend outwardly from the upper wall 122 and slope downwardly in a direction transverse to the upper wall 122. In such a configuration, the first beveled sidewall 124a transitions into a first rail base 126a, a portion of which may be substantially parallel to the upper wall 122, creating a flat surface. Similarly, the second beveled sidewall 124b transitions to form a second rail base 126b, which also has a portion that is substantially parallel to the upper wall 122, providing a flat surface.

Moreover, the first rail base 126a may include a first upturned flange 128a, which, in turn, forms a first trough 134a that extends along the longitudinal direction of the rail R. Similarly, the second rail base 126b may include a second upturned flange 128b, creating a second trough 134b, which also extends longitudinally along the rail R. These troughs 134a and 134b serve a function by helping to channel or divert water away from the solar panel array, thereby protecting the system from potential water damage.

The inclusion of the first upturned flange 128a also provides a clearance between a distal edge and the roof membrane, even if the rail R comes into contact with the membrane. Such a configuration helps prevent any direct pressure or abrasion on the roof membrane, reducing the risk of damage. The second upturned flange 128b similarly offers a clearance, such that both sides of the rail R are properly spaced from the roof membrane.

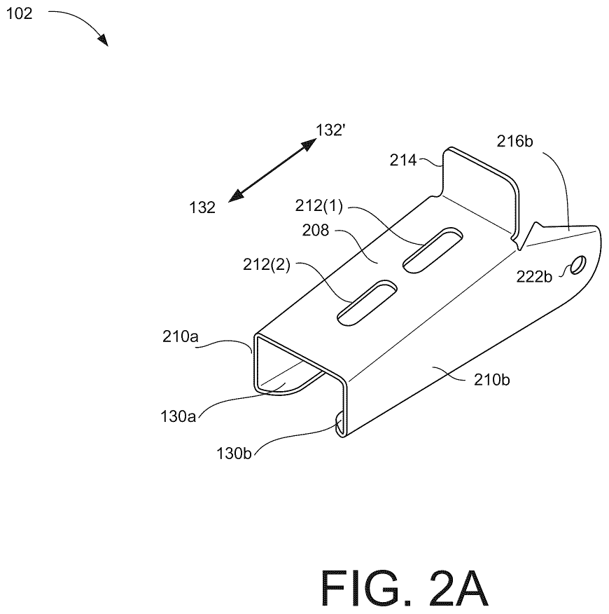

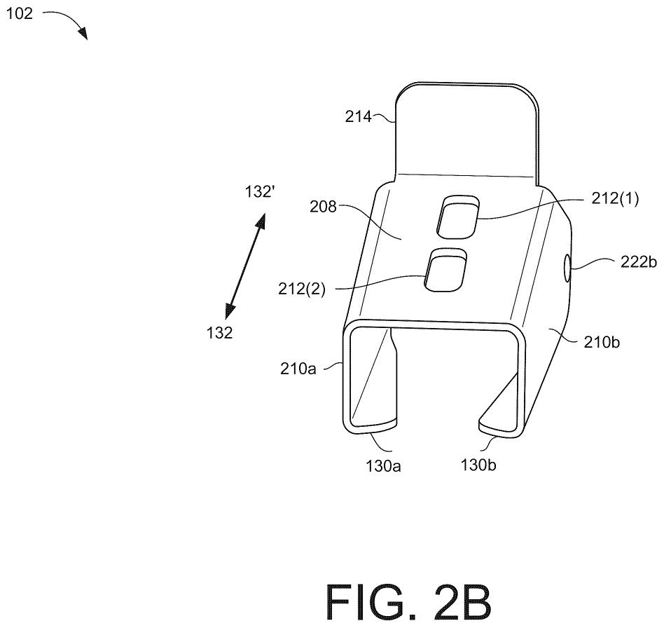

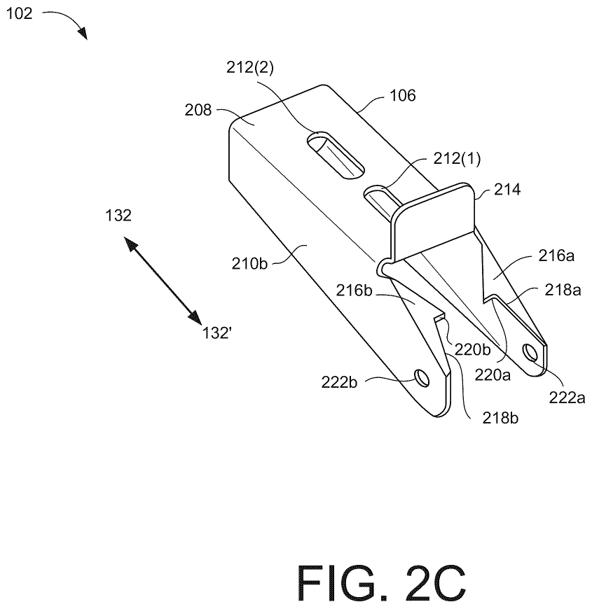

FIGS. 2A-2C illustrate the clamp base 102 from various angles, providing detailed views of the structure of the clamp base 102, according to an embodiment of this disclosure. FIG. 2A illustrates an isometric view of the clamp base 102, as depicted in FIG. 1, according to an embodiment of this disclosure. Referring to FIG. 2A, the clamp base 102 may include a panel flange support wall 208 and two clamp sidewalls 210a and 210b. The panel flange support wall 208 forms the upper surface of the clamp base 102.

The two clamp sidewalls, i.e., a first clamp sidewall 210a and a second clamp sidewall 210b, may extend downward from opposite edges of the panel flange support wall 208. The first clamp sidewall 210a and the second clamp sidewall 210b are spaced apart sufficiently to accommodate the rail R therebetween. The first and the second clamp sidewalls 210a and 210b may extend away from and transversely to the panel flange support wall 208 to which the clip 104 is connected.

Two mounting openings 222a and 222b may be formed in corresponding respective ends of each of the first and second clamp sidewalls 210a and 210b, such that the mounting openings 222a and 222b are coaxial. In an embodiment, the mounting openings 222a and 222b are aligned laterally to be horizontally positioned when installed on the rail.

Further, the first and second clamp sidewalls 210a and 210b extend beyond the length of the panel support wall 208 to form a channel therebetween. The channel is sized to accommodate the width of the upper portion of the rail R to allow the first and second clamp sidewalls 210a and 210b to partially straddle the rail R, whereby the pivoting fastener 106 (e.g., a clevis pin) may be inserted through the mounting openings 222a and 222b and the rail R (forming a pivot joint) to connect the clamp base 102 to the rail R.

The clamp base 102 may include one or more tapered flanges, such as the first tapered flange 130a and the second tapered flange 130b, which play a role in securing the engagement between the clamp base 102 and the rail R. For instance, the first tapered flange 130a extends inwardly from the first clamp sidewall 210a, while the second tapered flange 130b extends inwardly from the second clamp sidewall 210b. The first and the second tapered flanges 130a and 130b may be tapered gradually, increasing inwardly to allow the clamp assembly 100 to engage the beveled sidewalls of the rail R when mounted on the rail T and rotated against the rail R. The first and second tapered flanges 130a and 130b are configured to interlock with the corresponding beveled sidewalls of the rail R, creating a connection when the clamp base 102 is pivoted into a proper position.

It should be noted that while the shapes and dimensions of the first and second tapered flanges 130a and 130b are exemplary in the described embodiments, they are not restrictive. Depending on specific implementation requirements, the angles and dimensions of the tapered flanges may be adjusted to optimize the engagement between the clamp base 102 and the rail R.

The panel flange support wall 208 may include one or more clamp openings, such as a first clamp opening 212(1) and a second clamp opening 212(2), configured to facilitate the attachment and movement of the clip 104. The first clamp opening 212(1) and the second clamp opening 212(2) may take various shapes depending on the actual requirements, including circular, rectangular, elliptical, triangular, hexagonal, slotted, or other custom shapes. In the embodiment depicted in FIG. 2A, the first clamp opening 212(1) and the second clamp opening 212(2) are slotted openings. The slotted shape is configured to provide flexibility in the positioning and adjustment of the clip 104. By being oriented in the longitudinal direction 132-132′ of the clamp base 102, the slotted openings allow the clip 104 to pivot and slide along the length of the clamp base 102, facilitating alignment and attachment between the clip 104 and the clamp base 102.

Additionally, the clamp base 102 may further include a panel support ledge 214 extending from and transversely to the panel flange support wall 208 of the clamp base 102. The panel support ledge 214 is positioned to abut an outside wall of the frame of a solar panel module during installation. As such, the panel support ledge 214 extends away from the panel flange support wall 208 in a direction opposite to the direction of extension of the first and second sidewalls 210a and 210b. Additionally, a width direction of the panel support ledge 214 extends in a plane that is orthogonal to respective planes extending through the first and second sidewalls 210a and 210b. In an embodiment, the panel support ledge 214 extends at an angle ranging, e.g., from 25 to 100 degrees, or more, relative to the panel flange support wall 208 of the clamp base.

The panel support ledge 214 is configured to enhance the overall stability and support of the solar panel module during installation. For instance, one end of the upper surface of the clamp base 102 may extend upwards from the main body of the clamp base 102 to form the panel support ledge 214. The panel support ledge 214 is configured to provide support to the solar panel module.

The clamp base 102 may further include pivot restraining features configured to limit the amount of rotation between the clamp assembly 100 and the rail R. For instance, the pivot restraining features may include a first protrusion 216a (not shown in FIG. 2A, but illustrated in FIG. 2C) and a second protrusion 216b, configured to engage with rail R. The first protrusion 216a may extend inwardly from an edge of the first clamp sidewall 210a, while the second protrusion 216b may extend inwardly from an edge of the second clamp sidewall 210b. The first protrusion 216a is positioned between the panel support ledge 214 and the first mounting opening 222a (not shown in FIG. 2A, but illustrated in FIG. 2C), while the second protrusion 216b is similarly located between the panel support ledge 214 and the second mounting opening 222b on the opposite side.

FIG. 2B illustrates another isometric view of the clamp base 102, as depicted in FIG. 1, according to an embodiment of this disclosure. FIG. 2C illustrates yet another isometric view of the clamp base 102, as depicted in FIG. 1, according to an embodiment of this disclosure. In FIG. 2B and FIG. 2C, the same reference numbers are used to indicate the same elements as shown in FIG. 2A, allowing for easy correlation between the figures.

Referring to FIG. 2C, the first protrusion 216a may include a first tapered portion 218a, while the second protrusion 216b may include a second tapered portion 218b. The first tapered portion 218a and the second tapered portion 218b are shaped to properly engage with the first beveled sidewall 124a and the second beveled sidewall 124b of the rail R, respectively. Such engagement may occur when the clamp base 102 is pivoted to approximately 90 degrees relative to the upper wall 122 of the rail R, as illustrated in FIG. 1. Each of the first and the second protrusions 216a and 216b may include a vertex point, oriented to interfere with the rotational trajectory of the clamp base 102 about the pivot axis by engagement with the upper wall 122 of the rail R. Thus, the rotation may be stopped via contact between the horizontal vertex point and the surface of the rail R. While the specific shape of the first and the second protrusions 216a and 216b may vary, in an embodiment as shown, each of the first and the second protrusions 216a and 216b may be defined as an elongated flange that extends inwardly tapering from one or both ends of the elongation direction of the clamp base 102, forming a stopping point. In an embodiment, the taper of the elongated flange tapers such that the clamp base 102 would engage a beveled sidewall of the rail R in an increasing amount of abutment to slow the engagement and minimize flexion on the pivot joint. In an embodiment, the pivot restraining feature is configured to engage the top surface of the rail R when the clamp base 102 is rotated to an upright position that is about 90 degrees (e.g., between 80-110) relative to the upper wall 122 of the rail R.

Further, the first protrusion 216a may be configured with a first abutment 220a, and the second protrusion 216b may be configured with a second abutment 220b. The first abutment 220a and the second abutment 220b, also referred to as vertex points, are configured to limit the rotational movement between the clamp assembly 100 and the rail R. For instance, the first abutment 220a and the second abutment 220b are configured to engage with the rail R in such a way that the first abutment 220a and the second abutment 220b may restrict the clamp base 102 from rotating beyond a predetermined angle. For example, the first abutment 220a and the second abutment 220b may be formed at angles that are transverse to the longitudinal dimension 132-132′ of the clamp base 102. Additionally, the first abutment 220a and the second abutment 220b may be oriented orthogonally relative to the first clamp sidewall 210a and the second clamp sidewall 210b, respectively.

FIG. 3 illustrates a bottom isometric view of the clip 104 depicted in FIG. 1A, according to an embodiment of this disclosure. Referring to FIG. 3, the clip 104 may be formed as an elongated component defined, at least in part, by a length dimension (x direction), a width dimension (y direction), and a thickness dimension (z direction). In an embodiment, the clip 104 may include a clip opening 310 through the thickness dimension thereof. The clip opening 310 may be sized to allow passage of the biasing fastener 108 to connect the clip 104 to the panel support wall 208 of the clamp base 102. Example types of clip opening 310 may include but are not limited to holes, apertures, etc. In an embodiment, the clip opening 310 may be threaded. Thus, the biasing fastener 108 (such as a bolt) may be threaded therethrough such that the clip 104 may function similarly to a “nut” when threaded on the biasing fastener 108. However, it is conceivable that other connection and tightening means are possible.

The clip 104 may include a front lip 304 and a back lip 306. The front lip 304 may protrude downwardly along the −z direction from a first side of the body 302 of the clip 104, while the back lip 306 may protrude downwardly along the −z direction from an opposing second side of the body 302 of the clip 104.

The clip 104 may include one or more tabs, such as the first tab 116a and the second tab 116b, which extend downwardly along the −z direction from the back lip 306 and are positioned on opposite sides of the clip 104 to enhance stability and functionality. These tabs are folded at opposing sides of the clip 104, corresponding to the width direction of the clamp base 102. When the clip 104 is connected to the clamp base 102, the first tab 116a and the second tab 116b extend over the first sidewall 210a and the second sidewall 210b, respectively, of the clamp base 102, effectively preventing rotation of the clip 104. In an embodiment, the first tab 116a and the second tab 116b may be located at opposite corners at one end of the clip 104.

During the clamping process, as the biasing fastener 108 is tightened, the spring 112 helps the first tab 116a and the second tab 116b to engage against the clamp base 102, further stabilizing the clip 104. Conversely, when the biasing fastener 108 is loosened, the clip 104 may be rotated when the clip 104 is pulled away from the clamp base 102.

When the clip 104 is engaged with the clamp base 102, the first tab 116a on one side and the second tab 116b on the opposite side work together to restrict axial rotation of the clip 104 around the axis of the biasing fastener 108.

The clip 104 may further include one or more grips, such as a first grip (not visible in FIG. 3) and a second grip 312b. The first grip may extend upwards along the z direction from a third side of the body 302 of the clip 104, while the second grip 312b may extend upwards along the z direction from an opposing fourth side of the body 302 of the clip 104. The first grip and the second grip 312b are configured to facilitate the installation process by providing a proper grasp point for the user.

In some embodiments, the second grip 312b may include one or more cavities, such as a first cavity 314(1) and a second cavity 314(2), which are configured to enhance manual control when handling the clip 104. The first cavity 314(1) and the second cavity 314(2) not only improve grip but also help reduce the overall weight of the clip, thus facilitating convenient handling and installation. The first cavity 314(1) and the second cavity 314(2) may be configured as partial holes or through holes, depending on specific design requirements, such as the need for weight reduction, structural reinforcement, or ease of manufacturing. Although FIG. 3 depicts two cavities, it should be noted that additional or fewer cavities could be incorporated based on the application.

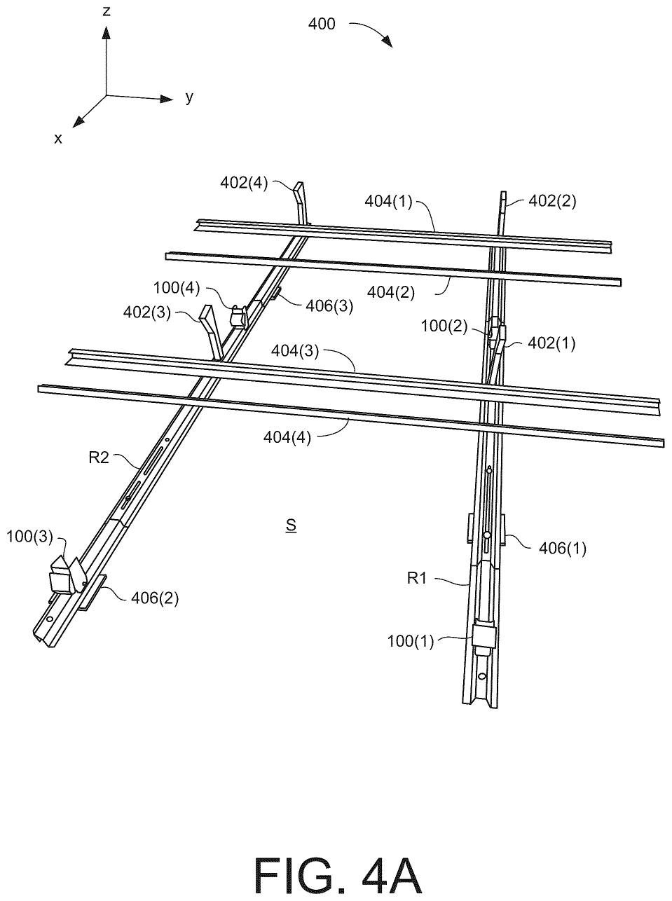

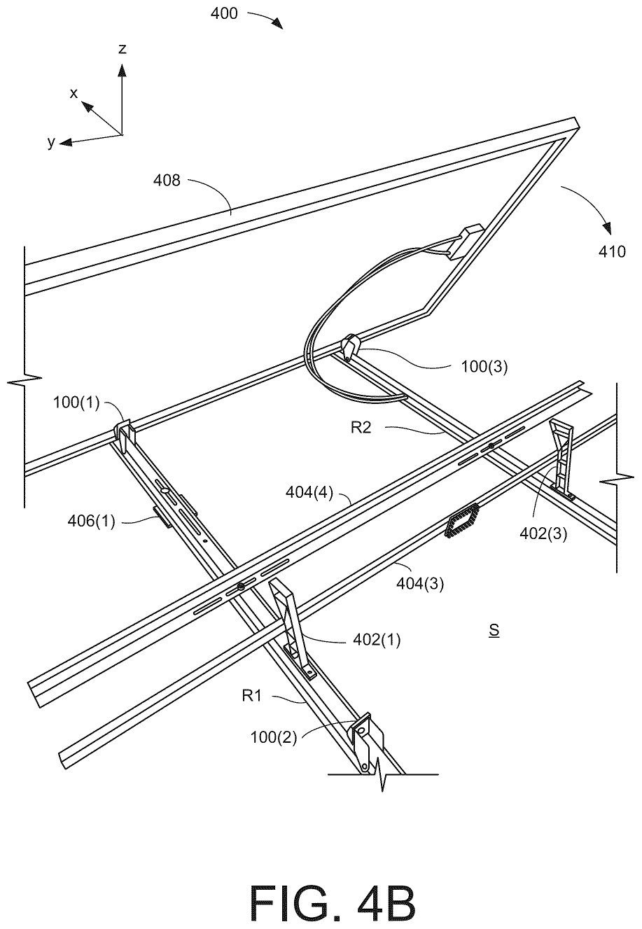

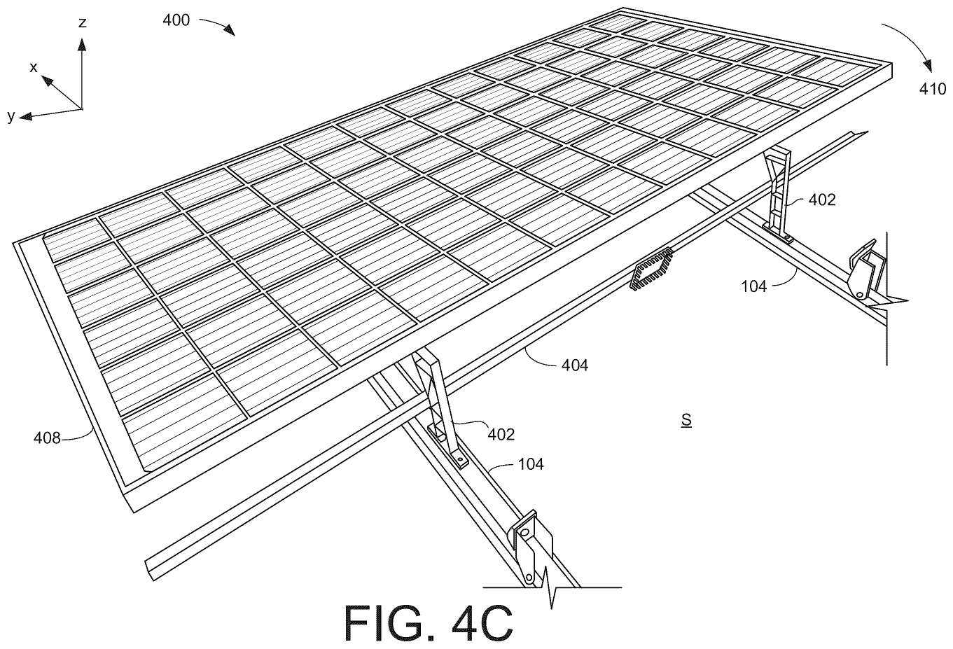

FIG. 4A illustrates an expanded view of a solar panel module mounting system 400 before installation of a solar panel module, according to embodiments of this disclosure. Referring to FIG. 4A, the mounting system 400 may include a plurality of rails, such as a first rail R1 and a second rail R2. While FIG. 4A depicts two rails, it should be noted that the number of rails may be customized based on specific installation requirements, allowing for either fewer or additional rails to accommodate different solar panel configurations. The first rail R1 and the second rail R2 are configured to be positioned on a surface S of a roof or a platform. In addition, while FIGS. 4A-4C show an example solar panel module system 400 of which clamp assembly 100 is a component, clamp assembly 100 may be used in different solar panel module mounting systems and different environments without departing from the spirit and scope of the present disclosure.

Both the first rail R1 and the second rail R2 may extend in parallel along the x-direction. In addition to providing support for the solar panels, the first rail R1 and the second rail R2 are also configured to allow for the attachment of other components, such as ballast rails, clamps, and other structural elements, enhancing the overall versatility and adaptability of the mounting system 400 to meet various installation needs.

The mounting system 400 may further include a plurality of ballast rails positioned across the plurality of rails, such as a first ballast rail 404(1), a second ballast rail 404(2), a third ballast rail 404(3), and a fourth ballast rail 404(4). Although FIG. 4A illustrates four ballast rails, it should be noted that the number of ballast rails may be adjusted based on specific requirements, allowing for either fewer or additional ballast rails as needed. The plurality of ballast rails are positioned to extend along the y-direction, which is perpendicular to the x-direction.

The first ballast rail 404(1) and the second ballast rail 404(2) may be paired together and attached to both the first rail R1 and the second rail R2. Similarly, the third ballast rail 404(3) and the fourth ballast rail 404(4) may be paired and attached to the first rail R1 and the second rail R2.

The mounting system 400 may further include a plurality of clamp assemblies, such as a first clamp assembly 100(1), a second clamp assembly 100(2), a third clamp assembly 100(3), and a fourth clamp assembly 100(4). Although FIG. 4A illustrates four clamp assemblies, it should be noted that the number of clamp assemblies may be adjusted based on specific requirements, allowing for either fewer or additional clamp assemblies as needed.

The first clamp assembly 100(1) and the second clamp assembly 100(2) may be attached to the first rail R1, while the third clamp assembly 100(3) and the fourth clamp assembly 100(4) may be attached to the second rail R2. In some embodiments, the first clamp assembly 100(1) and the third clamp assembly 100(3) may be paired to support a solar panel module, while the second clamp assembly 100(2) and the fourth clamp assembly 100(4) may be paired to support another solar panel module.

In one embodiment, the first clamp assembly 100(1) may be positioned along the longitudinal dimension of rail R1 nearest the fourth ballast rail 404(4), providing an anchoring point for a solar panel module. Similarly, the second clamp assembly 100(2) may be attached to rail R1 along the longitudinal dimension of the rail R1 between the two pairs of ballast rails. On the opposite side, the third clamp assembly 100(3) may be attached to rail R2 along the longitudinal dimension of the rail R2 nearest the fourth ballast rail 404(4). The fourth clamp assembly 100(4) may be attached to rail R2 along the longitudinal dimension of the rail R2 between the two pairs of ballast rails.

The mounting system 400 may further include a plurality of stanchions, such as a first stanchion 402(1), a second stanchion 402(2), a third stanchion 402(3), and a fourth stanchion 402(4). While FIG. 4A depicts four stanchions, it should be noted that the number of stanchions may be adapted based on specific installation needs, allowing for either fewer or additional stanchions as required.

In some embodiments, the first stanchion 402(1), the second stanchion 402(2), the third stanchion 402(3), and the fourth stanchion 402(4) may be positioned and attached at the “south end” of the mounting system 400. The first stanchion 402(1) and the second stanchion 402(2) may be paired and attached to the first rail R1, while the third stanchion 402(3) and the fourth stanchion 402(4) may be paired and attached to the second rail R2. In one embodiment, the first stanchion 402(1) may be positioned along the z-direction on the rail R1 between the two pairs of ballast rails. Similarly, the second stanchion 402(2) may be attached to the rail R1 along the z-direction nearest the first ballast rail 404(1). On the opposite side, the third stanchion 402(3) may be attached to the rail R2 along the z-direction between the two pairs of ballast rails. The fourth stanchion 402(4) may be attached to the rail R2 along the z-direction near the first ballast rail 404(1).

The mounting system 400 may further include one or more pads, such as a first pad 406(1), a second pad 406(2), and a third pad 406(3). While FIG. 4A illustrates three pads, the number of pads may be customized based on specific installation requirements, allowing for either fewer or additional pads as necessary. The first pad 406(1), the second pad 406(2), and the third pad 406(3) are configured to protect the mounting surface S of a roof or other platforms where the mounting system 400 is installed.

The first pad 406(1) may be positioned between the first rail R1 and the mounting surface S, while the second pad 406(2) and the third pad 406(3) may be placed between the second rail R2 and the mounting surface S.

FIG. 4B illustrates a partial view of the solar panel module mounting system 400 depicted in FIG. 4A, showing an intermediate stage of the installation process for the solar panel module 408, according to embodiments of this disclosure. In FIG. 4B, the mounting system 400 is rotated 180 degrees relative to the view presented in FIG. 4A, offering an alternative perspective on the installation process.

Referring to FIG. 4B, in the intermediate stage of the installation, the solar panel module 408 is attached to the mounting system 400 via a pair of clamp assemblies, that is, the first clamp assembly 100(1) and the third clamp assembly 100(3). The first clamp assembly 100(1) is pivotally attached to the first rail R1, while the third clamp assembly 100(3) is pivotally attached to the second rail R2. After the solar panel module 408 has been fastened to both the first clamp assembly 100(1) and the third clamp assembly 100(3), the solar panel module 408 may be rotated or pivoted downward via the first clamp assembly 100(1) and the third clamp assembly 100(3) along the direction indicated by arrow 410 towards a pair of stanchions, that is, the first stanchion 402(1) and the third stanchion 402(3).

FIG. 4C illustrates a partial view of the solar panel module mounting system 400 depicted in FIG. 4A, showing the final stage of the installation process for the solar panel module 408, according to embodiments of this disclosure. In FIG. 4C, the mounting system 400 is presented from the same perspective as in FIG. 4B, but rotated 180 degrees relative to the view shown in FIG. 4A. As described herein, the solar panel module 408 is attached to the mounting system 400 via a pair of clamp assemblies, namely the first clamp assembly 100(1) and the third clamp assembly 100(3) (not shown in FIG. 4C, but illustrated in FIGS. 4A and 4B).

Referring to FIG. 4C, at this final stage of installation, the solar panel module 408 is shown pivoted or rotated downward into a finished position through the rotation of the first clamp assembly 100(1) and the third clamp assembly 100(3) along the direction 504, where the solar panel module 408 rests upon a pair of stanchions, that is, the first stanchion 402(1) and the third stanchion 402(3). The first stanchion 402(1) and the third stanchion 402(3) are configured to provide support to the solar panel module 408.

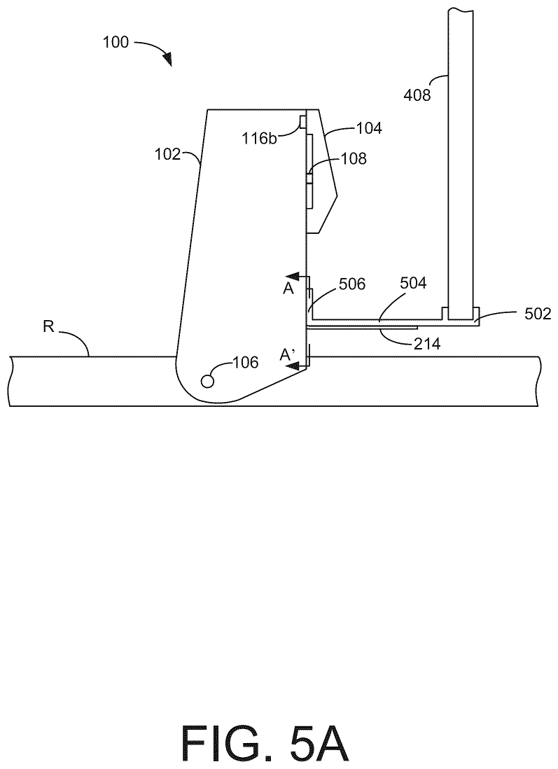

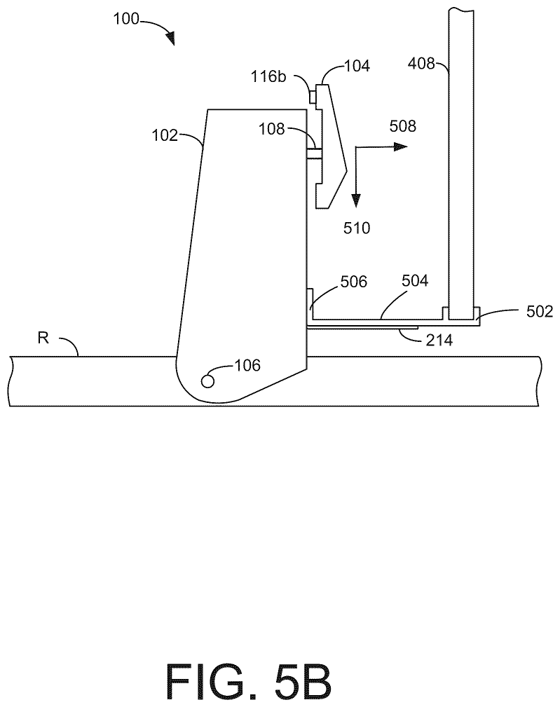

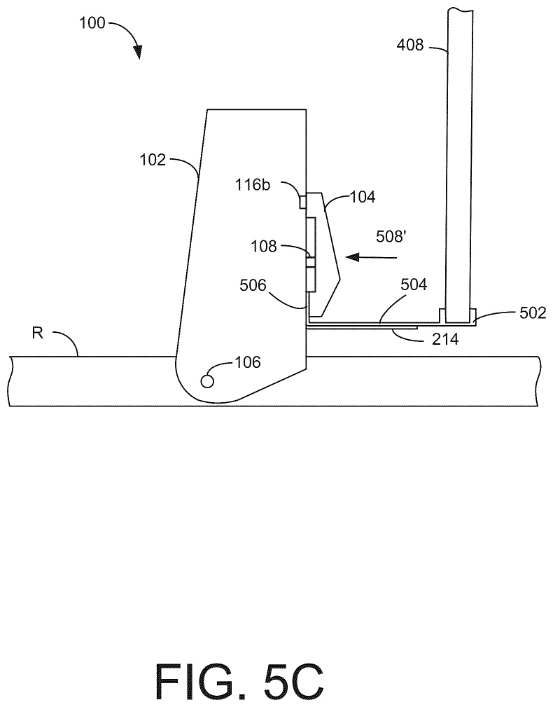

FIGS. 5A-5C provide various views of the clamp assembly 100 along with the solar panel module 408 during various stages of the clamping process. FIG. 5A illustrates a side view of the clamp assembly 100 along with a frame 502 of the solar panel module 408 in a first stage of the installation process, according to an embodiment of this disclosure. Referring to FIG. 5A, at this first stage, the clamp assembly 100 is connected to the rail R via a pivoting fastener 106, which serves as the rotational axis, allowing the clamp assembly 100 to pivot relative to the rail R. Next, the clamp assembly 100 is rotated into an upright position, where the clamp assembly 100 is substantially perpendicular to the top surface of the rail R, thereby setting the stage for the subsequent installment of the solar panel module 408. The clip 104 is attached to the clamp base 102 via a biasing fastener 108.

The frame 502 of the solar panel module 408 may include a frame sidewall 504 and a return flange 506. The frame sidewall 504 is configured to rest against the panel support ledge 214. As described herein, the panel support ledge 214 is configured to provide additional support for the solar panel module 408.

The panel support ledge 214 may extend at a right angle from the sidewall 504 of the solar panel module frame 502. The panel support ledge 214 is configured to work with the clip 104.

FIG. 5B illustrates a side view of the clamp assembly 100 along with the frame of the solar panel module 408 during a second stage of the clamping process, according to embodiments of this disclosure. In this second stage, as depicted in FIG. 5B, the clip 104 is pulled in the direction 508 away from the clamp base 102 along the axis of the fastener 108. Such a movement allows the clip 104 to disengage from its initial position and provides the necessary clearance for further adjustment. Next, the clip 104 may be slid in a longitudinal direction 510 along the clamp base 102, moving towards the return flange 506 of the solar panel frame 502. This sliding action is guided through either the first clamp opening 212(1) or the second clamp opening 212(2) (not visible in FIG. 5B, but shown in FIG. 1 and FIGS. 2A-2C).

Alternatively, the clip 104 may be rotated instead of slid along the clamp base 102, using the same clamp openings. As described herein, the first clamp opening 212(1) and the second clamp opening 212(2) may be configured as slotted apertures, which facilitate the movement, adjustment, and positioning of the clip 104.

FIG. 5C illustrates a side view of the clamp assembly 100 along with the frame 502 of the solar panel module 408 during a third stage of the clamping process, according to embodiments of this disclosure. At this third stage, as shown in FIG. 5C, the clip 104 is returned toward the clamp base 102 along direction 508′, either through a spring bias mechanism, threaded engagement, or similar means. Such a motion allows the clip 104 to move back into position, allowing the clip 104 to exert clamping force on the return flange 506 of the frame 502. Upon reaching the proper position, the clip 104 effectively clamps against the inner surface of the return flange 506 of the solar panel module 408.

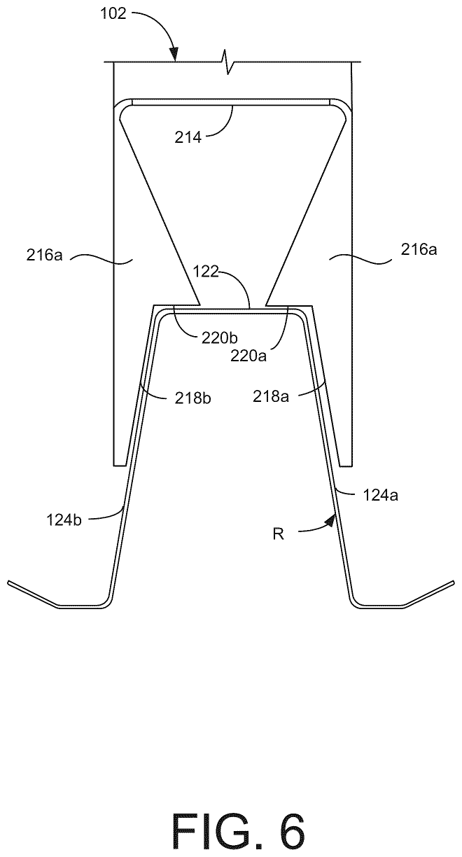

FIG. 6 illustrates a cross-sectional view of the clamp base 102 along with the rail R as seen from line A-A′ in FIG. 5A, according to embodiments of this disclosure. Referring to FIG. 6, the first protrusion 216a includes a first tapered portion 218a and a first abutment 220a, while the second protrusion 216b features a second tapered portion 218b and a second abutment 220b. The first tapered portion 218a is configured to engage with the first beveled sidewall 124a of the rail R, while the second tapered portion 218b is configured to engage with the second beveled sidewall 124b of the rail R. The first abutment 220a and the second abutment 220b are configured to engage with the upper wall 122 of the rail R.

The first tapered portion 218a and the second tapered portion 218b are shaped to properly engage with the first beveled sidewall 124a and the second beveled sidewall 124b of the rail R, respectively. Such engagement may occur when the clamp base 102 is pivoted to approximately 90 degrees relative to the upper wall 122 of the rail R, as illustrated in FIG. 5A. Each of the first and the second protrusions 216a and 216b may include a vertex point, oriented to interfere with the rotational trajectory of the clamp base 102 about the pivot axis by engagement with the upper wall 122 of the rail R. Thus, rotation of the clamp base 102 may be stopped via contact between the horizontally vertex point and the surface of the rail R. While the specific shape of the first and the second protrusions 216a and 216b may vary, in an embodiment as shown, each of the first and the second protrusions 216a and 216b may be defined as an elongated flange that extends inwardly tapering from one or both ends of the elongation direction of the clamp base 102, forming a stopping point. In an embodiment, the taper of the elongated flange tapers such that the clamp base 102 would engage a beveled sidewalls 124a and 124b of the rail 102 in an increasing amount of abutment to slow the engagement and minimize flexion on the pivot joint. In an embodiment, the pivot restraining feature is configured to engage the top surface of the rail R when the clamp base 102 is rotated to an upright position that is about 90 degrees (between 80-110) relative to the upper wall 122 of the rail R.

The configuration of the clamp assembly 100 is optimized to simplify the installation process, requiring only a single tool—a wrench—to attach the solar panel module 408 to the clamp assembly 100. The ability to perform the entire installation with just one tool not only streamlines the assembly process but also enhances the safety of the personnel involved. By minimizing the tools needed, the risk of dropping tools from height or losing grip during installation is reduced, contributing to an efficient installation process.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A clamp assembly for securing a solar panel module, comprising:
a clamp base;
a clip movably connected to the clamp base; and
a biasing fastener extending through the clamp base and the clip, the biasing fastener being configured to bias the clip from the clamp base.

2. The clamp assembly of claim 1, wherein the clamp base comprises a clamp opening through which the biasing fastener extends, and wherein the clip is movable through the clamp opening.

3. The clamp assembly of claim 1, wherein the clamp base further comprises a panel support ledge configured to support a frame of the solar panel module.

4. The clamp assembly of claim 1, wherein the clamp base comprises a first protrusion and a second protrusion configured to engage a rail.

5. The clamp assembly of claim 1, wherein the clip is configured to rotate relative to the clamp base.

6. The clamp assembly of claim 1, wherein the clip is configured to slide along a longitudinal direction of the clamp base.

7. The clamp assembly of claim 1, wherein the clip comprises a biasing component configured to apply a force to the clip when the clip is pulled away from the clamp base.

8. The clamp assembly of claim 1, further comprising a pivoting fastener configured to connect the clamp base to a rail pivotally.

9. A mounting system for mounting a solar panel module, comprising:
a plurality of rails;
a plurality of clamp assemblies attached to the plurality of rails, wherein one of the plurality of clamp assemblies comprises:
a clamp base;
a clip movably connected to the clamp base; and
a biasing fastener extending through the clamp base and the clip, the biasing fastener being configured to bias the clip from the clamp base.

10. The mounting system of claim 9, wherein the clamp base comprises:
a panel flange support wall including at least one clamp opening through which the biasing fastener extends; and
a first clamp sidewall and a second clamp sidewall configured to engage with a rail of the plurality of rails.

11. The mounting system of claim 10, wherein
the first clamp sidewall comprises a first tapered flange extending inwardly from the first clamp sidewall; and
the second clamp sidewall comprises a second tapered flange extending inwardly from the second clamp sidewall.

12. The mounting system of claim 10, wherein the clamp base further comprises a panel support ledge on the panel flange support wall, the panel support ledge being configured to support a frame of the solar panel module.

13. The mounting system of claim 9, wherein the clamp base further comprises a first protrusion and a second protrusion configured to engage the rail.

14. The mounting system of claim 13, wherein the first protrusion comprises:
a first tapered portion configured to engage with a first beveled sidewall of the rail; and
a first abutment configured to engage with an upper wall of the rail.

15. The mounting system of claim 9, wherein the clip comprises:
a front lip extending along a first direction from a first side of a body of the clip;
a back lip extending along the first direction from a second side of the body of the clip, the second side being opposite to the first side;
a first grip extending along a second direction from a third side of the body of the clip;
a second grip extending along the second direction from a fourth side of the body of the clip, the fourth side being opposite to the third side, the second direction being opposite to the first direction; and
a first tab and a second tab extending downwards from the back lip, the first tab and a second tab being configured to engage with a return flange of a frame of the solar panel module.

16. The mounting system of claim 9, further comprising a plurality of stanchions attached to the plurality of rails, the plurality of stanchions being configured to provide additional support for the solar panel module.

17. The mounting system of claim 9, further comprising a plurality of ballast rails positioned across the plurality of rails.

18. The mounting system of claim 9, further comprising a plurality of pads positioned between the plurality of rails and a mounting surface.

19. A method of mounting a solar panel module to a mounting system via a clamp assembly, the clamp assembly comprising a clip and a clamp base, the method comprising:
placing a frame of the solar panel module on the clamp base of the clamp assembly;
pulling away the clip in a first direction from the clamp base;
rotating the clip or sliding the clip along the clamp base in a second direction; and
returning the clip toward the clamp base to clamp against a return flange of the frame of the solar panel module.

20. The method of claim 19, further comprising rotating the clamp assembly with respect to a rail of the mounting system.
